(19) United States
(12) Patent Application Publication
(10) Pub. No.: US 2006/0287947 A1
(43) Pub. Date: Dec. 21, 2006

(54) Non-payment risk assessment

(76) Inventor: Alvin David Toms, London (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/238,584

(22) Filed: Sep. 29, 2005

(30) Foreign Application Priority Data
Jun. 16, 2005 (AU) 2005903142

(51) Int. Cl. G06Q 40/00

(52) U.S. Cl. 705/38

(57) ABSTRACT

Methods, means and apparatus for performing a payment risk assessment include training a predictive model with past unsecured credit application data with good and bad outcomes and inputting a new unsecured credit application into the predictive model to produce an assessment of the risk that the unsecured credit applicant will not pay. In addition, methods and means of providing a service to perform a payment risk assessment for credit applications are described including training a predictive model with past unsecured credit application data with good and bad outcomes, offering to perform a payment risk assessment for credit applications in return for a fee, receiving only unsecured credit applications and inputting a new unsecured credit application into the predictive model to produce an assessment of the risk that the unsecured credit applicant will not pay.

### RELATED APPLICATIONS

This application claims priority to, and incorporates by reference, the entire disclosure of Australian Provisional Application No. 2005903142, filed on Jun. 16, 2005.

### FIELD OF THE INVENTION

The present invention relates to assessment of risk of non-payment of credit supplied to an applicant.

### BACKGROUND

Credit is provided to applicants directly and indirectly. Direct credit is provided where money is given on the promise of repayment, such as in the case of a bank loan or credit card payment for a purchase. Indirect credit is provided where a good or service is provided in advance of payment for the good or service, such as the supply of a telephone and access to the telephone network.

Predictive models, such as neural networks have been used in the past in an attempt to assess whether an applicant for credit is a significant non-payment risk to the credit provider. However the results of such use have been mixed. As a result, predictive models have been regarded as unreliable in assessing credit applicants for risk of non-payment.

This in turn has resulted in virtually all companies that require approvals for credit applications to consider predictive models to be unreliable. Consequently they utilise only the more traditional credit scoring methodology. This usually consists of utilising credit bureaus that use historical data, such as court judgments, length of employment and other historical fields of data relevant to the applicant. Alternatively such companies may develop an internal system to assess the credit worthiness of each applicant.

### SUMMARY OF THE PRESENT INVENTION

According to a first aspect of the present invention there is provided a method of performing a payment risk assessment for credit applications comprising training a predictive model with past unsecured credit application data with good and bad outcomes and inputting a new unsecured credit application into the predictive model to produce an assessment of the risk that the unsecured credit applicant will not pay.

Preferably the method comprises providing the new unsecured credit application.

According to a second aspect of the present invention there is provided a means for performing a payment risk assessment for credit applications comprising a predictive model, means for training the predictive model with past unsecured credit application data with good and bad outcomes and means for inputting a new unsecured credit application into the predictive model to produce an assessment of the risk that the unsecured credit applicant will not pay.

According to a third aspect of the present invention there is provided a method for assessing a payment risk for credit applications comprising providing a predictive model trained with past unsecured credit application data with good and bad outcomes and receiving a new unsecured credit application into the predictive model to produce an assessment of the risk that the unsecured credit applicant will not pay.

According to a fourth aspect of the present invention there is provided an apparatus for assessing a payment risk for credit applications comprising a predictive model trained with past unsecured credit application data with good and bad outcomes and input means for receiving a new unsecured credit application into the predictive model to produce an assessment of the risk that the unsecured credit applicant will not pay.

Preferably the trained predictive model is configured to recognise patterns in the applications of applicants that do not intend to pay. Preferably the predictive model is adaptive such that the patterns recognised change with time as underlying disguising of the identity or intentions of credit applicants change with time.

According to a fifth aspect of the present invention there is provided a method of providing a service to perform a payment risk assessment for credit applications comprising training a predictive model with past unsecured credit application data with good and bad outcomes, offering to perform a payment risk assessment for credit applications in return for a fee, receiving only unsecured credit applications and inputting a new unsecured credit application into the predictive model to produce an assessment of the risk that the unsecured credit applicant will not pay.

Preferably the predictive model is the only system used to assess payment risk for unsecured credit applicants.

Alternatively the predictive model is the only system offered to perform payment risk assessment for unsecured credit applications in return for a fee.

Preferably the fee is charged on a per application assessed basis.

According to a sixth aspect of the present invention there is provided a computer program configured to control a computer to perform any one of the above defined methods.

According to a seventh aspect of the present invention there is provided a computer program configured to control a computer to operate as any one of the above defined means/apparatus.

According to an eighth aspect of the present invention there is provided a computer readable storage medium comprising a computer program as defined above.

### DESCRIPTION OF DRAWINGS

In order to provide a better understanding of the present invention preferred embodiments will now be described in greater detail, by way of example only, with reference to the accompanying drawings, in which:

FIG. 1 is a schematic representation of a preferred embodiment of an apparatus according to the present invention; and

FIG. 2 is a schematic flowchart of a method according to a preferred embodiment of the present invention.

### DETAILED DESCRIPTION OF PREFERRED EMBODIMENTS

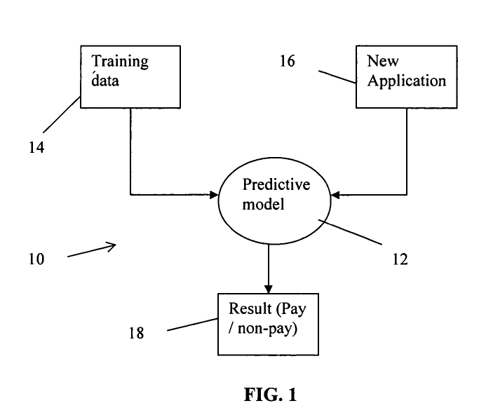

Referring to FIG. 1 there is a predictive model 12, typically in the form of a neural network, which is trained using training data 14. The predictive model 12 is usually in the form of a computer loaded with suitable software to control the computer to operate as a neural network. The training causes the predictive model to learn the relationships between past applicants' information and the outcome of credit repayments. Once trained the predictive model is provided with information relating to a new credit application. Such information will usually include the name, address, telephone number, age, time in job, accommodation type, income etc . . . of the credit applicant.

The trained predictive model will apply the learnt relationships to the new applicant's information which will produce an expected outcome of the provision of credit should it be given. Typically this will be in the form of “good credit risk” or “bad credit risk”, where a person with a good credit risk is likely to pay their bills/repayments and a person with a bad credit risk is likely to not pay their bills/repayments.

Other more sophisticated results may be given, such as a confidence rating etc. . .

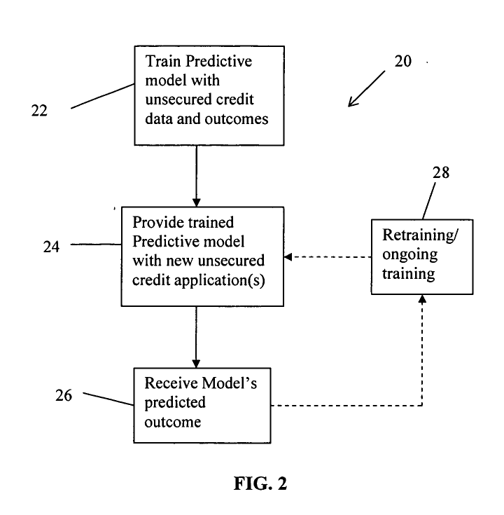

Referring to FIG. 2, a process 20 of assessing credit risk by the predictive model 12 is shown. The process starts with training 22 the predictive model as described above. The trained predictive model is provided 24 with new unsecured credit applications. The predictive model then outputs 26 the predicted outcome should the applicant be given the credit applied for, or some other representation of risk. This can be compared with actual outcomes and the predictive model can be retrained periodically or be given ongoing training 28.

It is important to understand that all credit applications fall into two distinct categories, which are:
secured applications for credit require that the applicant secure (or at least partially secure) the credit advance against realisable assets; and
unsecured applications for credit do not require any security to be put up by the applicant.

The inventor has come to the unexpected realisation that in the case of secured credit applications, the applicant has no incentive to misrepresent any data as whatever amounts in cash or goods the applicant obtains from the lender is secured. Therefore, the information in these applications is almost certainly true. They can be vetted more successfully by traditional methods of establishing if the amount lent (whether in cash or goods) is within their means to repay as described above via credit bureaus that utilise applicant specific historical data.

When predictive models are utilised in assessing the credit worthiness of secured credit applications they attempt to do so on the basis of information derived from their training data sets. These training datasets are usually more limited than those used by credit bureaus and hence the internal representation of the predictive model will usually be somewhat inferior to the processes of the data bureau simply because the bureaus scoring system is implemented against a richer set of historical data. Predictive models that do not have access to the historical data of the specific applicant are less accurate than the traditional scoring methodology used by credit bureaus.

Whereas in the case of unsecured credit applications, no security is required to be deposited by the applicant, therefore there arises a large propensity for the attraction of endemic payment defaulters. These defaulters have no motivation to provide true and correct data. The predictive model which has been trained on historical fact such as previous actual good and bad results can learn to differentiate between the types of applications that are more likely to be bad or good regardless of whether the data is true or not.

It is able to do this because there are patterns in the application data that imply whether the data is true or not. In the case of fabricated data, and this occurs because people tend to fabricate data in a particular manner or style which, in itself, can provide an indication that the applicant is likely to default or not.

In support of this there are some standard statistical tests that can reveal such patterns, such as chi-squared tests for deviations from Benford's law. Predictive models can learn more subtle and obscure patterns than these within the application data of the training dataset that assist in evaluating whether the application contains information that is true or false.

Conventional credit assessment systems often perform very poorly when working with false data because they rely heavily on historical data relating to the specific applicant. For example if the applicant has provided a false identity, historical information relating to the identity will be irrelevant and severely misleading, meaning that the performance of conventional credit assessment mechanisms is worse in unsecured lending where there is a concentration of dishonest applicants than in secured lending where applicants tend to be honest.

The additional subtle pattern analysis capabilities of predictive models provide significant uplift in accuracy for unsecured creditors when compared to secured creditors and resolves the reasons for the earlier ambiguous results that were obtained from the usage of predictive models within the credit industry.

What was not previously realised was that because the credit applications themselves varied by type this difference accounted for the variance in the performance of predictive models, which was directly related to the type of credit applications processed. This then was the reason for the apparent ambiguities in the predictive model performance and was not therefore a technical problem with the predictive models themselves.

It would be typical for the training data of one field, such as the field of telecommunications service provision to be used only for applications for unsecured credit in the same field. Likewise applications for unsecured credit in one field would typically only use a predictive model trained on data from the same field. Another example of such a field would be credit card lending. This need not be the case though because patterns of false information made by fraudsters may be uniform among all or groups of unsecured credit fields.

In summary:

i) Conventional systems tend to perform relatively well in secured lending where applicants provide accurate identifying information that can be used by conventional credit bureaus to check their credit history with other lenders of the same type. Non-credit bureau businesses usually do not have access to credit history information (especially in the second and third world countries) and hence they cannot provide this information to predictive models. Without this information the predictive models struggle to match the performance of the credit bureaus.

ii) Conventional systems tend to perform relatively poorly in unsecured lending because the potential to profit through dishonesty attracts dishonest applicants who misrepresent themselves when applying. This misrepresentation means that the conventional credit bureaus cannot use identifying information to access a person's credit history and use it to assess their application. Since this is the most predictive information used in conventional credit bureaus, their performance tends to be poor without it.

iii) Even when dishonest information is provided by credit applicants there will be patterns in the information that can be learnt by example from previous good and bad results contained within a predictive model's training data set. For example, dishonest applicants must avoid being located and hence must avoid providing a permanent address or traceable phone number. Similarly, dishonest applications tend to have different statistical properties to honest applications, one example of such a difference being detectable by deviations from Benford's law, with the result that the distinctions between them can be learnt.

A skilled addressee will realise that modifications and variations may be made to the present invention without departing from the basic inventive concept. Such modifications and variations are intended to fall within the scope of the present invention, the nature of which is to be determined form the foregoing description.

1. A method of performing a payment risk assessment for credit applications comprising:
training a predictive model with past unsecured credit application data with good and bad outcomes;
inputting a new unsecured credit application into the predictive model to produce an assessment of the risk that the unsecured credit applicant will not pay.

2. A method according to claim 1, wherein the method further comprises providing the new unsecured credit application.

3. A means for performing a payment risk assessment for credit applications comprising:
a predictive model;
means for training the predictive model with past unsecured credit application data with good and bad outcomes;
means for inputting a new unsecured credit application into the predictive model to produce an assessment of the risk that the unsecured credit applicant will not pay.

4. A method for assessing a payment risk for credit applications comprising:
providing a predictive model trained with past unsecured credit application data with good and bad outcomes;
receiving a new unsecured credit application into the predictive model to produce an assessment of the risk that the unsecured credit applicant will not pay.

5. An apparatus for assessing a payment risk for credit applications comprising:
a predictive model trained with past unsecured credit application data with good and bad outcomes;
input means for receiving a new unsecured credit application into the predictive model to produce an assessment of the risk that the unsecured credit applicant will not pay.

6. An apparatus according to claim 5, wherein the trained predictive model is configured to recognise patterns in the applications of applicants that do not intend to pay.

7. An apparatus according to claim 6, wherein the predictive model is adaptive such that the patterns recognised change with time as underlying disguising of the identity or intentions of credit applicant change with time.

8. A method of providing a service to perform a payment risk assessment for credit applications comprising:
training a predictive model with past unsecured credit application data with good and bad outcomes;
offering to perform a payment risk assessment for credit applications in return for a fee;
receiving only unsecured credit applications;
inputting a new unsecured credit application into the predictive model to produce an assessment of the risk that the unsecured credit applicant will not pay.

9. A method according to claim 8, wherein the predictive model is the only system used to assess payment risk for unsecured credit applicants.

10. A method according to claim 8, wherein the predictive model is the only system offered to perform payment risk assessment for unsecured credit applications in return for a fee.

11. A method according to claim 10, wherein the fee is charged on a per application assessed basis.

12. A computer program configured to control a computer to perform any one of the methods defined in claims 1, 2, 4, or 8 to 11.

13. A computer program configured to control a computer to operate as the means defined in claim 3.

14. A computer readable storage medium comprising a computer program as defined in claim 13.

15. A computer program configured to control a computer to operate as the apparatus defined in any one of claims 5 to 7.

16. A computer readable storage medium comprising a computer program as defined in claim 15.
